(19) United States
(12) Patent Application Publication
(10) Pub. No.: US 2008/0111789 A1
(43) Pub. Date: May 15, 2008

(54) CONTROL DEVICE WITH HYBRID SENSING SYSTEM COMPRISED OF VIDEO-BASED PATTERN RECOGNITION AND ELECTRONIC SIGNAL TRANSMISSION

(75) Inventors: Hay YOUNG, New Territories (HK); Alex Tang, Kowloon (HK)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(73) Assignee: INTELLIGENCE FRONTIER MEDIA LABORATORY Ltd, Shatin (HK)

(21) Appl. No.: 11/937,209

(22) Filed: Nov. 8, 2007

Related U.S. Application Data
(60) Provisional application No. 60/865,053, filed on Nov. 9, 2006.

(51) Int. Cl. G06F 3/033

(52) U.S. Cl. 345/157

(57) ABSTRACT

The invention provides a method and apparatus for use as a control device for controlling a computing system. The method includes a hybrid sensing system comprised of computer-vision-based pattern recognition and electronic signal transmission. The control device is embedded with a designated color light pattern and an electronic signal transmitter. The color light pattern within the field of sight of a video image capturing device is detected and identified by a computing system. Methods for configuring the color light pattern are included. The control device can be handheld or attached to a human body. The movement of the color light pattern in the 3-dimensional space will provide 3-dimensional positional information of a virtual pointer to the computing system. The activation of the electronic signal transmitter by pressing a control button on the control device will trigger input commands to the computing system.

### CROSS-REFERENCE TO A RELATED APPLICATION

This application claims the benefit of provisional patent application No. 60/865,053 filed Nov. 9, 2006.

### FIELD OF THE INVENTION

The present invention relates to an input mechanism for computer systems.

### BACKGROUND OF THE INVENTION

An intuitive input device is important for human to communicate with the computer system. It helps user to interact with the computer systems in a more user-friendly way. Mouse is one of the input devices we use daily. The manipulation of a mouse can provide the computing system the 2-dimensional positional information of the pointer and input commands (the mouse click). In the case of a 3-dimensional mouse, it can also provide the 3-dimensional positional information of the pointer.

However, a mouse is not an easy-to-use input device for a new user, especially to children and elderly people. In fact, even for an experienced computer user, it is difficult for him/her to draw a picture with the mouse. There is a need to search for an input device which not only has all the functions of a mouse—capable of providing 2-dimensional or 3-dimensional positional information of the pointer and triggering input commands, but also is much more intuitive to use.

Image based control system using a video camera to scan a field of sight for detecting the activation of a specific region on the video screen by a moving body was developed to offer an alternative input mechanism for a computing system (Very Vivid, Inc., U.S. Pat. No. 5,534,917). However, the above-mentioned solution can only detect pixel changes on the video screen and cannot function like a mouse to give accurate positional information of the pointer and input commands. Other image based control systems using color patch [Ref 1] or color light source [Ref 2] [Ref 3] are experimented by many research labs. The color patch or color light source is detected by a camera to generate 2-dimensional positional information of the pointer to the computing system. Yet it too lacks of the capacity of triggering input commands. Sony Computer Entertainment Inc. developed another alternative input device (Patent Application Pub. No.: US 2005/073838 A2) which uses the color change of LED light source as an indicator of the input of a mode change.

However, all these prior arts with the detection of color patch or color light source for generating positional information of the pointer and triggering input commands have an intrinsic weakness: the detection of color patch or color light source is easy to get interfered by other colors and color light sources scattering and uncontainable in our “colorful” living environment. Such input devices are apparently not robust enough to provide reliable accuracy regarding the positional information of the pointer and triggering input commands for a computing system.
[Ref 1] T. D. Grove, K. D. Baker, and T. N. Tan. Colour Based Object Tracking. Proceedings of the Fourteenth International Conference on Pattern Recognition, Brisbane, Australia, 1998.
[Ref 2] G. Bertini and P. Carosi. Light Baton System: A System for Conducting Computer Music Performance. Interface, Vol. 22(3), 243-257, 1993.
[Ref 3] G. Welch and E. Foxlin. Motion Tracking: No Silver Bullet, but a Respectable Arsenal. IEEE Computer Graphics and Applications, special issue on “Tracking,” 22(6): 24-38, 2002.

### SUMMARY OF THE INVENTION

The object of present invention is therefore to provide a method and apparatus to be used as a video image based control system capable of providing reliable accuracy regarding the 3-dimensional positional information of a pointer (such as a mouse pointer) and triggering input commands (such as mouse clicks) for the computing system, in an unconstrained, uncalibrated “colorful” living environment.

In order to achieve the above object, a first aspect of the current invention provides a hybrid sensing system comprised of:
(1) Computer-vision-based pattern recognition hereafter means the detection and identification of a patterned color light source within the field of sight of a video image capturing device of a computing system, wherein a patterned color light source is a designated pattern of two or more than two color light sources. A method of pattern recognition of the patterned color light source to exclude the interference of light emitted from other irrelevant sources is included. The movement of the color light pattern in the 3-dimensional space can provide 3-dimensional positional information of a virtual pointer to the computing system.
(2) Electronic signal transmission hereafter means feeding electronic signals to the computing system so as to trigger input commands to a computing program. It is functionally similar to a mouse click event or a button selection of the game pad.

Further, a second aspect of the current invention provides an apparatus which hereafter means a control device configured with:
(1) A designated pattern of color light source capable of being detected and identified by a computing system using the said method of computer-vision-based pattern recognition. Methods for configuring the color light pattern are included. The movement of the control device in the 3-dimensional space within the field of sight of a video image capturing device can provide 3-dimensional positional information of a virtual pointer to the computing system.
(2) An electronic signal transmitter capable of sending electronic signals to the computing system so as to trigger input commands to a computing program. When pressing the control button on the control device, the device will transmit a signal to the computing system. It is functionally similar to a mouse click event or a button selection of the game pad. A method of configuring the control buttons is included.

Further, a third aspect of the current invention provides a method of pattern recognition of a designated configuration of color light source includes:
(1) Reducing the amount of light allowed into the aperture of an image capturing device. The camera admits only luminous light sources and excludes the “colored” background of the living environment.
(2) Identifying a designated patterned color light source within the field of sight of a video image capturing device. Methods of identifying the designated patterned color light source are included. The interference of light emitted from other irrelevant sources is excluded.

Further, a fourth aspect of the current invention provides an estimation of the 2-dimensional planar coordinates of an identified patterned color light source within the field of sight of a video image capturing device. The 2-dimensional planar position of the identified patterned color light source affixed on the input device is then translated to become the 2-dimensional position of the virtual pointer in the computer system.

Still further, a fifth aspect of the current invention provides an estimation of the orientation of a control device by calculating the angle of the color light pattern with reference to the local coordinates of the video image within the field of sight of a video image capturing device.

Still further, a sixth aspect of the current invention provides an estimation of the relative 3-dimensional depth of an identified patterned color light source. The relative distance between the control device and the capturing device is obtained by comparing the size of two successive patterned color light sources within the field of sight of a video image capturing device. The method of estimating the relative 3-dimensional depth of the identified patterned color light source is provided.

Further, a seventh aspect of the current invention provides a control system capable to detect and identify simultaneously multiple control devices affixed with different configurations of patterned color light sources and different electronic signals. Hence, this control system allows a single user or a group of users to control multiple pointers and trigger multiple input commands simultaneously.

Further, an eighth aspect of the present invention provides a control system to trigger input commands at a program running on a computing system. A video image capturing device and an electronic signal transmitter are includes. Logics for adjusting the amount of light allowed into the aperture of an image capturing device are included. Logics for detecting and identifying a patterned color light source to provide information of 2-dimensional coordinates, relative 3-dimensional depth and the orientation about a control device are included. Logics for sending and detecting an electronic signal for triggering an input command are included.

Further, a ninth aspect of the present invention provides an interface comprised of a computing system and a control device. The control device includes a designated pattern of color light source and an electronic signal transmitter capable of being detected and identified by a computing system. The control device can be held by a human hand or attached to the human body for use in a living environment. The movement of a control device in the 3-dimensional space within the field of sight of a video image capturing device is capable to control the 2-dimensional coordinates, relative 3-dimensional depth and the orientation of a virtual pointer of a program running on a computing system. The pressing of a control button on the control device can trigger an input command to a program running on a computing system. Multiple control devices affixed with different configurations of patterned color light sources and different electronic signal transmitters are capable to control the coordinates of multiple virtual pointers and trigger multiple input commands, respectively and simultaneously, at a program running on the computing system.

Other aspects and advantages of the invention will be set forth in the following detail description, illustrated by accompanying drawings, or in part will become obvious from the description, or may be learned by practice of the invention.

### BRIEF DESCRIPTION OF THE DRAWINGS

Embodiments of the present invention, with further advantages thereof, will now be described with reference to the accompanying drawings:

FIG. 1 is a schematic view of a system of the present invention capable to detect and identify 2-dimensional coordinates, relative 3-dimensional depth and the orientation of a patterned color light source, and trigger input commands for a computing system.

FIG. 2A is a diagram showing one configuration of a patterned color light source affixed on the control device in accordance with one embodiment of the present invention.

FIG. 2B is a diagram showing a 3-dimensional view of the configuration of the patterned color light source in FIG. 2A.

FIG. 2C is a diagram illustrating images captured by an image capturing device with the control device placed at different orientation in FIG. 2A.

FIG. 2D is a diagram showing an alternative configuration of a patterned color light source affixed on the control device in accordance with another embodiment of the present invention.

FIG. 2E is a diagram showing alternative embodiments having two control buttons for triggering different electronic signals.

FIG. 3 is a schematic diagram illustrating the capturing of a pattern of color light source affixed on the control device through an image capturing device in accordance with one embodiment of the present invention.

FIG. 4A is a schematic diagram illustrating the determination of the valid pattern of light source in accordance with one embodiment of the present invention.

FIG. 4B is a schematic diagram illustrating the determination of the valid pattern of light source in accordance with another embodiment of the present invention.

FIG. 5A is a schematic diagram illustrating the determination of the orientation (roll) of the control device in accordance with one embodiment of the present invention.

FIG. 5B is a schematic diagram illustrating the determination of the orientation (roll) of the control device in accordance with another embodiment of the present invention.

FIG. 6 is a schematic diagram illustrating the relationship between the scale of the captured image of a patterned color light source and its distance from the image capturing device in accordance with one embodiment of the present invention.

FIG. 7A is a schematic diagram illustrating the determination of the relative distance between the control device and the image capturing device (relative depth) with one embodiment of the present invention.

FIG. 7B is a schematic diagram illustrating the determination of the relative distance between the control device and the image capturing device (relative depth) with another embodiment of the present invention.

FIG. 8A is a diagram showing an alternative configuration of the pattern of color light source.

FIG. 8B is a diagram showing another configuration of the pattern of color light source.

FIG. 8C is a diagram showing yet another configuration of the pattern of color light source.

FIG. 9A is a simple illustration showing the frontal cross-section of the control device in accordance with one embodiment of the present invention.

FIG. 9B is a simple illustration showing the lateral cross-section of the control device in accordance with one embodiment of the present invention.

FIG. 9C is a diagram showing one configuration of LEDs in the control device in accordance with one embodiment of the present invention.

FIG. 10A is a simple illustration showing the frontal cross-section of the control device in accordance with another embodiment of the present invention.

FIG. 10B is a simple illustration showing the lateral cross-section of the control device in accordance with another embodiment of the present invention.

FIG. 10C is a diagram showing one configuration of LEDs in the control device in accordance with another embodiment of the present invention.

FIG. 11A is a diagram showing a control device being held in a human hand in one embodiment of the present invention.

FIG. 11B is a diagram showing a control device being attached to the human body in another embodiment of the present invention.

FIG. 12 is a flow chart diagram illustrating the method of getting input commands from a patterned color light source for a program run on a computing system.

FIG. 13 is a flow chart diagram illustrating the method of getting input commands from electronic signals for a program run on a computing system.

FIG. 14 is a flow chart diagram illustrating the method of pattern recognition for determining a valid pattern of color light sources.

### DESCRIPTION OF THE PREFERRED EMBODIMENTS

In the following descriptions, numerous specific details will now be made to explain, with reference to the accompanying drawings, the preferred embodiments of the present invention.

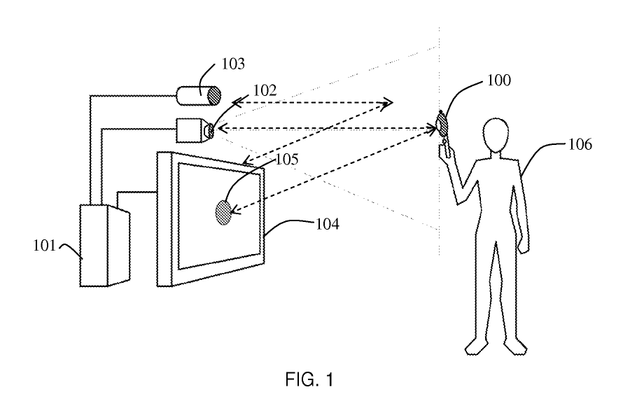

FIG. 1 is a schematic view of a system of the present invention capable to detect and identify 2-dimensional coordinates, relative 3-dimensional depth and the orientation (roll) of a patterned color light source, and trigger input commands for a computing system. It comprises a handheld control device 100, an image capturing device 102, a radio frequency (RF) receiver 103 and a computing system 101.

The computing system is configured with an image capturing device 102, RF receiver 103 and a display system 104. The image capturing device 102 is a CMOS image sensor with a lens. Yet it can be any image capturing device capable of detecting the patterned color light source affixed on the control device 100, for instant, a webcam, a digital camera, a camera coupled with a digitizer, or an array of charged coupled devices (CCDs), etc. The image capturing device 102 is targeting at the control device 100 such that the control device 100 is within the field of sight of the image capturing device 102.

The aperture of the image capturing device 102 is set to high contrast and low exposure so as to reduce the amount of light entering the CMOS image sensor, hence filter away the reflective colors on the background and weak light sources of the living environment. The patterned color light source on the control device 100 is a strong light source. The image capturing device 102 thus only captures the patterned color light source on the control device 100. RF receiver 103 is an electronic signal receiver of radio frequencies in one preferred embodiment. However, other electronic signal receivers can be used to receive other electronic signals, such as infrared. The location of the control device 100 is used to control the position of the virtual pointer 105 shown on the display system 104. Therefore, when the user 106 moves the control device 100 in the space, the virtual pointer 105 will move accordingly.

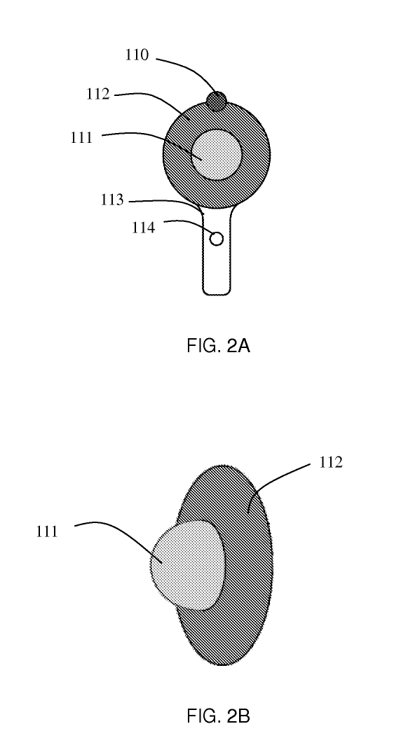

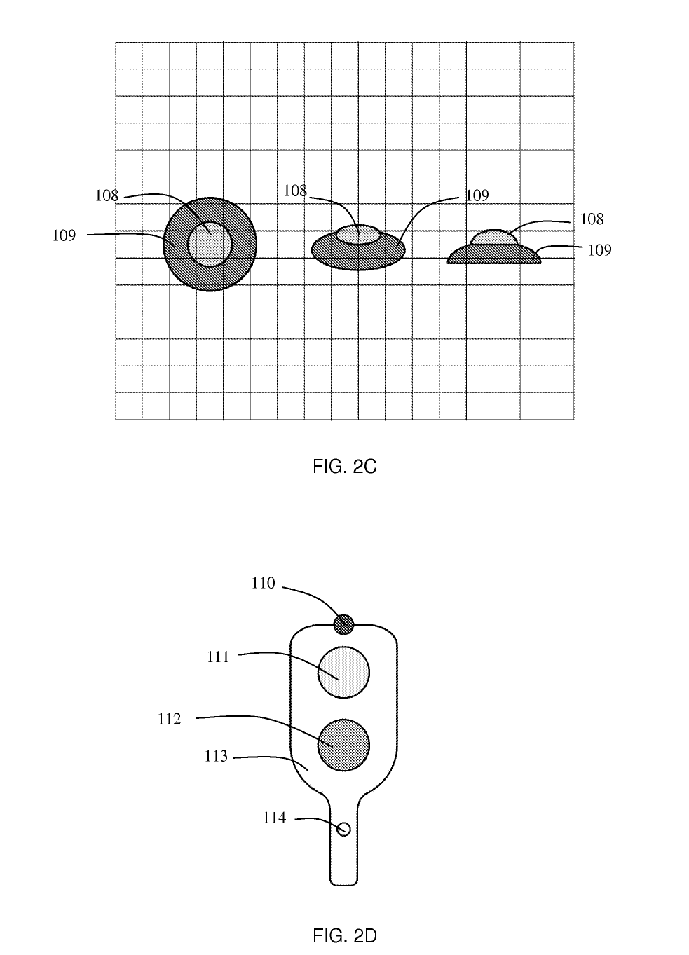

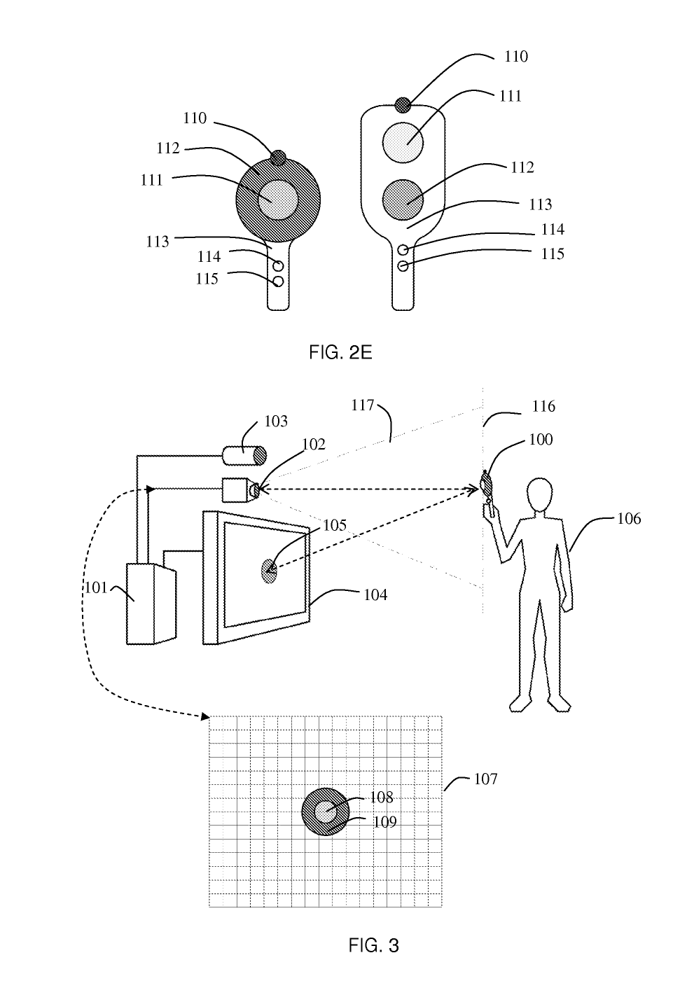

FIG. 2A is a diagram showing one configuration of a patterned color light source affixed on the control device in accordance with one embodiments of the present invention. The control device comprises of two well-contrasted color light sources 111 and 112, an RF transmitter 110, control buttons 114 and a battery power supply unit for the light sources and the RF transmitter 110. The color light sources 111 and 112 are both indirect light sources configured with a semi-transparent color filter and an array of LEDs affixed under the filter. In another embodiment, the color light sources 111 and 112 are both direct light sources configured with an array of color LEDs evenly distributed. LED is preferred to be the light source. But it is also possible to use other light sources, such as light bulbs, or good reflectors of light.

The two color light sources 111 and 112 are configured to be turned on when the power of the control device is switched on. This will produce a pattern of color light sources comprised of a primary light source 111 and a secondary light source 112, configured with one at the center 111 and the other forming an outer ring 112 to the center one 111. The one at the center 111 is smaller than the outer one 112. The purpose is to avoid occlusion when the control device is pointing toward the image capturing device. This color light pattern is capable of being detected and identified by a computing system using a method of computer-vision-based pattern recognition.

FIG. 2B is a diagram showing a 3-dimensional view of the configuration of the patterned color light source in FIG. 2A. The two color light sources 111 and 112 are configured to be on different 3-dimensional planes. The one at the center 111 is raised to a higher level than the outer ring 112. The purpose is to avoid occlusion when the control device is at an angle to the image capturing device.

FIG. 2C shows the image captured through an image capturing device with the control device placed at different orientation. The two color light sources 108 and 109 can be seen clearly by the image capturing device even when the orientation of the control device is at an orthogonal angle to the image capturing device.

FIG. 2D is a diagram showing an alternative configuration of a patterned color light source affixed on the control device in accordance with another embodiment of the present invention. Here the two color light sources 111 and 112 are configured to be turned on when the power of the control device is switched on. This will produce a patterned color light source comprised of a primary light source 111 and a secondary light source 112, both with approximately similar size, configured adjacently on a line and at a close distance to each other. This color light pattern is capable of being detected and identified by a computing system using a method of computer-vision-based pattern recognition.

FIG. 2E is a diagram showing two alternative embodiments having two control buttons 114 and 115 for triggering electronic signals. The control buttons 114 and 115 are configured to trigger the sending of different RF signals through the RF transmitter 110. The computer system receives the RF signal through an RF receiver and feedbacks with corresponding responses. In one embodiment, the response is the triggering of an input command to a computing program running on the computing system. It is functionally similar to a mouse click event or a button selection of the game pad. The user performs a mouse click or a button press by pressing one button on the control device. Apparently it is possible to add more buttons so that the control device can provide additional input commands to the computing system.

FIG. 3 is a schematic diagram illustrating the capturing of a pattern of color light source affixed on the control device through an image capturing device 102 in accordance with one embodiment of the present invention. The image capturing device 102 monitors a field of sight 117 through which the color light sources 100 is detected. The control device 100 is thus capable of being detected when the pattern of color light affixed on it is placed within the field of sight 117 of an image capturing device 102.

The patterned color light source in FIG. 2A-2E is now associated with the control device 100. The grid 107 is a digitized screen of the image capturing device, corresponding to the plane 116 with which the patterned color light source and thus the control device 100 is captured. The screen resolution of the grid 107 is associated with the resolution of the image capturing device 102. In the grid 107, which now represents the captured image of the patterned color light source, the inner circle 108 corresponds to the primary light source 111 (in FIG. 2A) of the control device 100 while the outer circle 109 corresponds to the secondary light source 112 (in FIG. 2A) of the control device 100. The other region of the image is black. This is because the image capturing device 102 is set with high contrast and low exposure so as to reduce the amount light getting into the aperture of the image capturing device 102. This can filter out the reflective color background and other weak light sources, which are irrelevant to the tracking process.

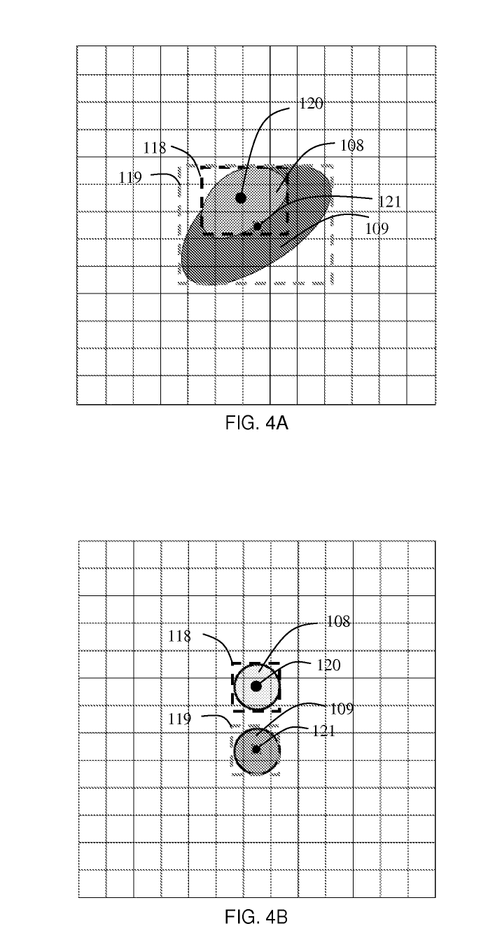

There might be other strong light sources in the environment. A method of pattern recognition described in FIG. 4A and FIG. 4B will exclude the interference from other light sources in the environment, no matter it is weak or strong. Thus, the image capturing device 102 is capable of detecting and identifying the patterned color light source affixed on the control device 100.

The position of the patterned color light source 108 and 109 in the grid 107 corresponds to the position of control device 100 on the plane 116. Hence, when the user 106 move the control device 100 on the plane 116, the position of the color light pattern 108 and 109 in the grid 107 will change accordingly. In one embodiment, this position will be used to control the position of the virtual pointer 105 in the display system 104. Hence, the user 106 can control the virtual pointer 105 in the display system 104 through moving of the control device 100.

FIG. 4A and FIG. 4B are schematic diagrams illustrating the determination of a valid pattern of light sources in accordance with two embodiments of the present invention. A method of computer-vision-based pattern recognition is defined as below.

The first step of the method of pattern recognition is to identify clusters of light sources with relevant colors. Relevant color hereafter means anyone of the two designated colors corresponding to the colors of the two color light sources affixed on the control device. Irrelevant color hereafter means any color not corresponding to the colors of the two color light sources affixed on the control device. The values of the pixels are analyzed so as to identify the color of each pixel. Pixels with irrelevant color captured from the reflective color background and other color light sources are ignored. Pixels with relevant color are joining together using a method of clustering. Small cluster is considered as noise, irrelevant, and ignored.

In two embodiments in accordance with FIG. 4A and FIG. 4B, two large clusters 108 and 109, respectively corresponding to two well-contrasted color light sources 111 (the primary light source) and 112 (the secondary light source) of the control device illustrated in FIG. 2A and FIG. 2D are captured and shown in the grid of a digitized screen. A bounding box hereafter means a quadrilateral, with edges parallel to the coordinate axes, includes the cluster inside. In FIGS. 4A and 4B, bounding boxes 118 and 119 are set to include cluster 108 and 109 respectively. The centroids 120 and 121 of the bounding box 118 and 119 are estimated respectively.

The next step of the method of pattern recognition is to determine if a valid color cluster pattern exists in the captured image. A color cluster pattern is hereafter defined as a pattern formed by clusters of relevant colors. A valid color cluster pattern is hereafter defined as a color cluster pattern with the centroids of two bounding boxes which include two color clusters with relevant colors, corresponding to a primary light source and a secondary light source of a control device, are located adjacently in close proximity.

In one embodiment in accordance with FIG. 4A and FIG. 4B, the centroid 120 (corresponding to the bounding box 118 of the primary light source) and centroid 121 (corresponding to the bounding box 109 of the secondary light source) are located closely adjacent to each other. The color cluster patterns in FIG. 4A and FIG. 4B are therefore defined as valid color cluster patterns.

In some cases, there might be a relevant color caused by another color light source in the living environment, and it forms a color cluster pattern with another relevant color detected within the field of sight of the image capturing device. However, by estimating its proximity to the other relevant color, it is possible to determine if it is a valid color cluster pattern. As a result, the interference from other light sources, no matter they have relevant color or irrelevant color, is reduced. The robustness of the control system of the present invention is greatly improved.

In order to support using multiple control devices simultaneously, other color combinations for two color light sources affixed on the control device can be chosen. A different color combination is associated with a different ID (identity) of a control device. For example, in one embodiment, a red and blue combination is used for control device A and a green and blue combination is used for control device B. The combination of the color should be carefully selected such that they have contrasting color characteristics so as to enable the computer to clearly identify them.

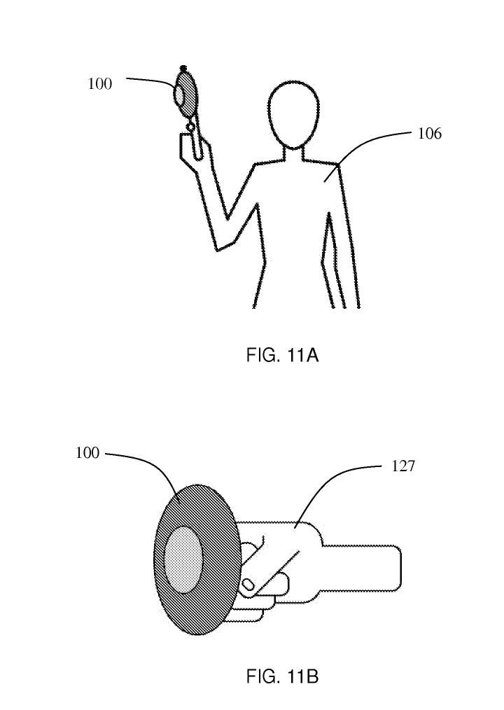

Detail process in the method of pattern recognition is further elaborated in the flow chart FIG. 11.

Once a patterned color light source with valid color cluster pattern is identified, the computing system then estimates the 2-dimensional planar coordinates of the patterned color light source. For simplicity, the centroid of the bounding box corresponding to the primary color light source affixed on the control device is associated with the location of the control device within the sight of an image capturing device. In FIG. 4A and FIG. 4B, the coordinates of centroid 120 on the grid, corresponding to the digitized screen 107 in FIG. 3, is estimated and defined as the 2-dimensional planar coordinates of the control device.

The 2-dimensional planar position of the identified patterned color light source affixed on the control device is associated with the 2-dimensional position of the virtual pointer in a computing system. It thus associates the position of the control device with the position of the virtual pointer in a computing system. Hence, one can control the 2-dimensional planar position of the virtual pointer displayed on a display system by simply moving the control device on a 2-dimensional plane.

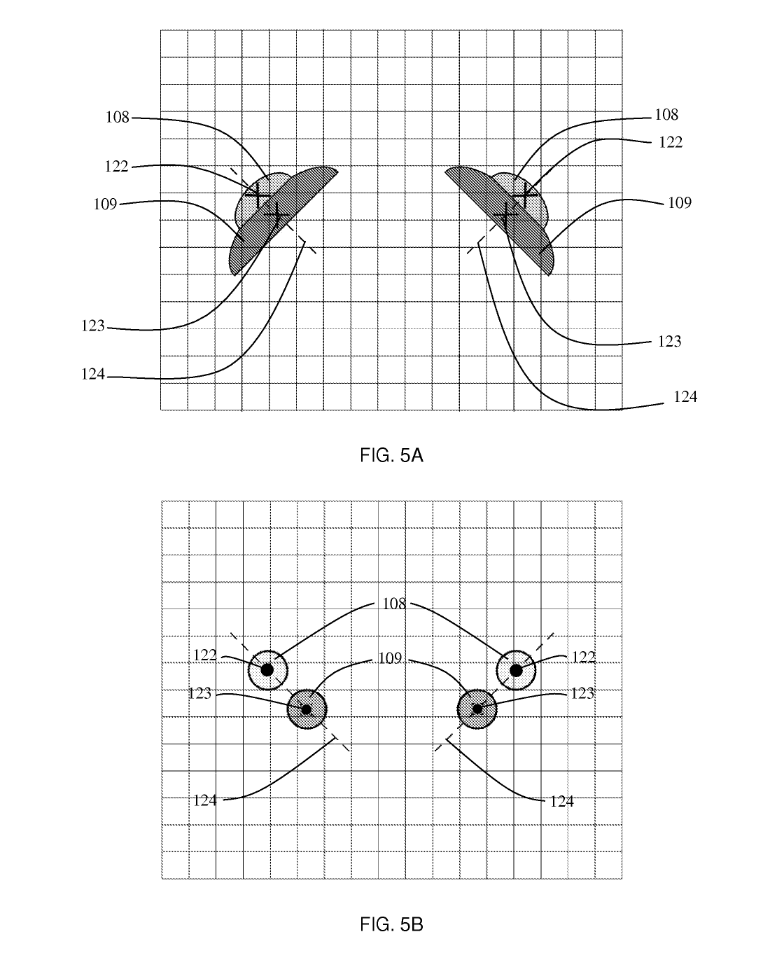

FIG. 5A and FIG. 5B are schematic diagrams illustrating the determination of the orientation (roll) of the control device in accordance with two embodiments of the present invention. The orientation (roll) of the control device can be estimated by finding the slope of a line 124 passing through the centroids 122 and 123 of the two clusters 108 and 109 caused by the two light sources on the same control device.

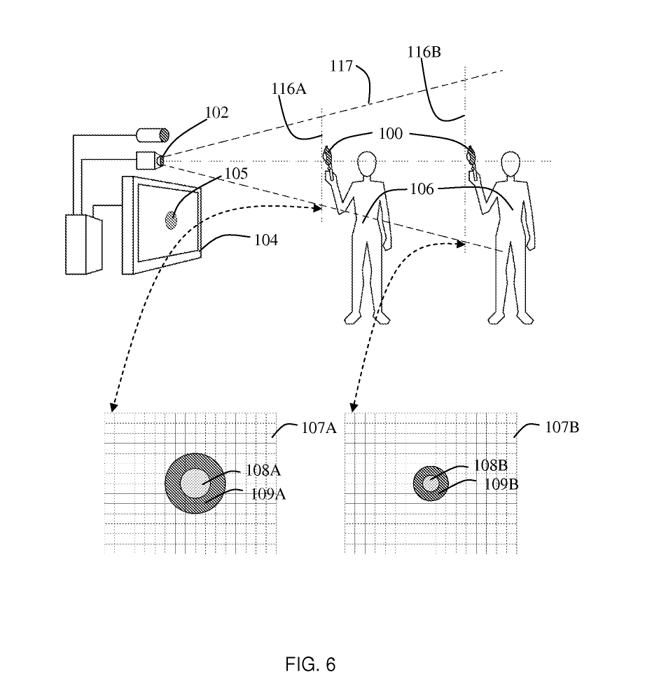

FIG. 6 is a schematic diagram illustrating the relationship between the scale of the captured image of a patterned color light source 100 and its distance from the image capturing device 102 in accordance with one embodiment of the present invention. The control device 100 is detected when it is placed within the field of sight 117 of an image capturing device 102. The grid 107A shows the captured image of the patterned color light source affixed on the control device 100 when the user 106 places the control device 100 at the position where the plane 116A lies. The inner circle 108A corresponds to the primary light source of the control device 100 while the outer circle 109A corresponds to the secondary light source of the control device 100. The grid 107B shows the captured image of the patterned color light source affixed on the control device 100 when the user 106 places the control device 100 at the position where the plane 116B lies, which is farther away from the image capturing device 102 than plane 116A. The inner circle 108B corresponds to the primary light source of the control device 100 while the outer circle 109B corresponds to the secondary light source of the control device 100.

By comparing the captured image of the patterned color light source in grid 107A and grid 107B, it is clear that when the user 106 moves away from the image capturing device 102, the size of the patterned color light source as seen by the image capturing device 102 will be reduced. The size of the inner circle 108B and outer circle 109B are scaled down when compared to 108A and 109A respectively. Hence, the user 106 can control the 3-dimensional depth of the virtual pointer 105 in the display system 104 by moving of the control device 100 towards or away from the image capturing device 102.

As the current video image based detection depends on whether the patterned color light source can be observed clearly by the image capturing device 102, the configuration of the patterned color light source affixed on the control device 100, in accordance with one embodiment of current invention, will work well in a distance ranging from 0.5 m to 1.7 m away from the image capturing device 102. One who is skilled in the art knows that if scaling the size of the patterned color light source affixed on the control device 100, the user can move much farther away than 1.7 m, as long as the image capturing device 102 can detect the patterned color light source.

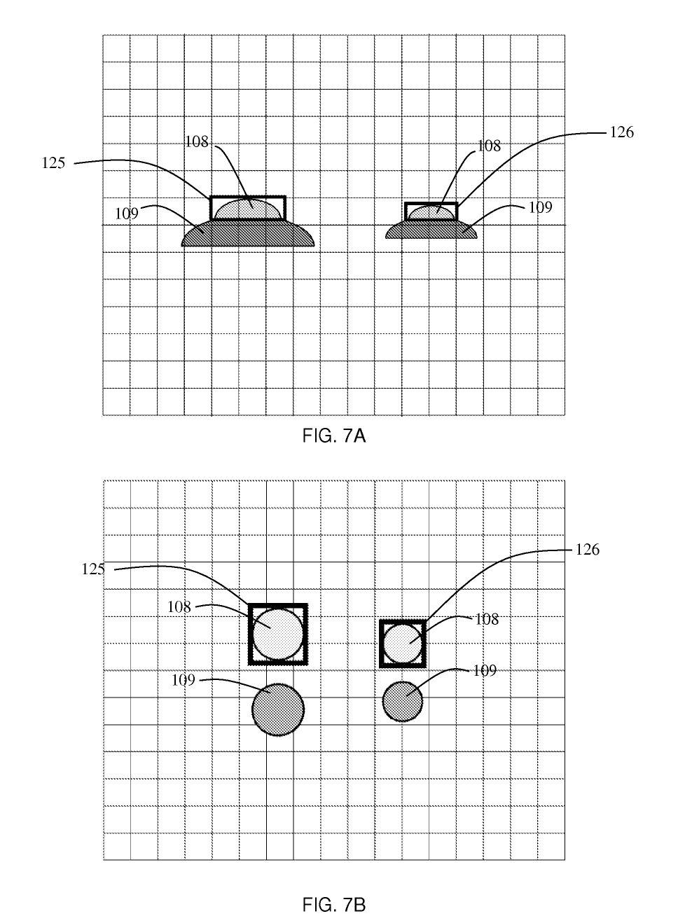

FIG. 7A and FIG. 7B are schematic diagrams illustrating the determination of the relative 3-dimensional depth of the control device, which is defined as the relative distance between the control device and the image capturing device, in two embodiments of the present invention. The relative 3-dimensional depth is determined by comparing two successive captured images of the patterned color light source the size of the bounding box 125 of the cluster 108 caused by the primary color light source. The bigger the bounding box 125 means the shorter the distance between the control device and the image capturing device.

With the information of 2-dimensional planer position, relative 3-dimensional depth and orientation (roll) of the control device, one can perform complex control over a virtual pointer of a computing system. Moreover, with the discrete event triggered by the control buttons, some complex interactions like point-and-click, drag-and-drop are capable of being performed.

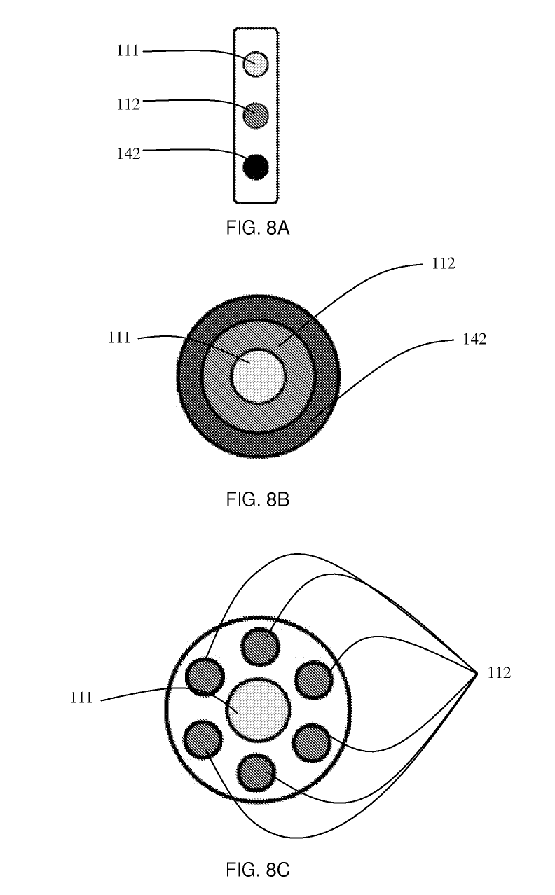

FIG. 8A and FIG. 8B are diagrams showing alternative configurations of the pattern of color light source. Three color light sources 111, 112 and 142 are used to form a valid patterned color light source. This can reduce the chance of having the same pattern of color light sources formed by other light sources in the environment.

FIG. 8C is a diagram showing another alternative configuration of the pattern of color light source. A primary color light source 111 and a ring of secondary color light sources 112 are used to form a valid patterned color light source.

The alternative configurations in FIG. 8A-8C also allow more freedom in designing a control device. The only condition is: there should be only one primary color light source 111 as this is a reference for the position of the control device. One who is skilled in the art knows that other configurations of the patterned color light source capable of being detected and identified using the above-mentioned method of pattern recognition can be designed in order to adapt to requirements of the application.

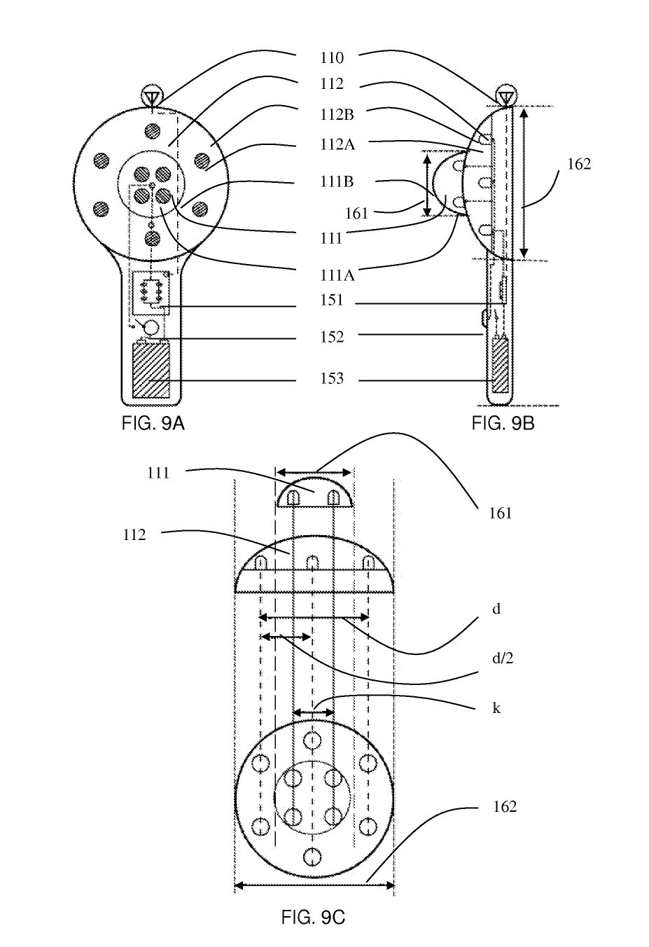

FIG. 9A and FIG. 9B are simple illustrations showing respectively the frontal and lateral cross-section of the control device in accordance with one embodiment of the present invention. The control device comprises a radio frequency (RF) antenna 110, a primary light source 111 which includes four 5 mm white LEDs such as LED 111A configured underneath a color filter 111B, a secondary light source 112 which includes six 5 mm white LEDs such as LED 112A configured underneath a color filter 112B, an integrated circuit 151 for controlling the RF antenna 110 and the electricity supply to the LEDs, a battery for supplying 4.5V electricity to the LEDs and the RF antenna 110, and a switch 152 for controlling the powering on and off of the control device. The LEDs are super bright LEDs with 10000 millcandela (mcd) intensity. The diameter 161 of the semi-transparent color filter 111B is 3 cm and the diameter 162 of the semi-transparent color filter 112B is 7 cm. The luminosities of the color light sources 111 and 112 are configured to be bright enough such that their colors can be identified by the computing system through the image capturing device which is configured with low exposure.

FIG. 9C is a diagram showing one configuration of LEDs in the control device in accordance with one embodiment of the present invention. The primary light source 111 comprised four LEDs evenly located, forming two groups separated by a distance k. The secondary light source 112 comprised six LEDs evenly located, forming three groups separated by a distance d/2. The diameter 161 of the hemispherical color filter 111B is 3 cm and the diameter 162 of the hemispherical color filter 112B is 7 cm.

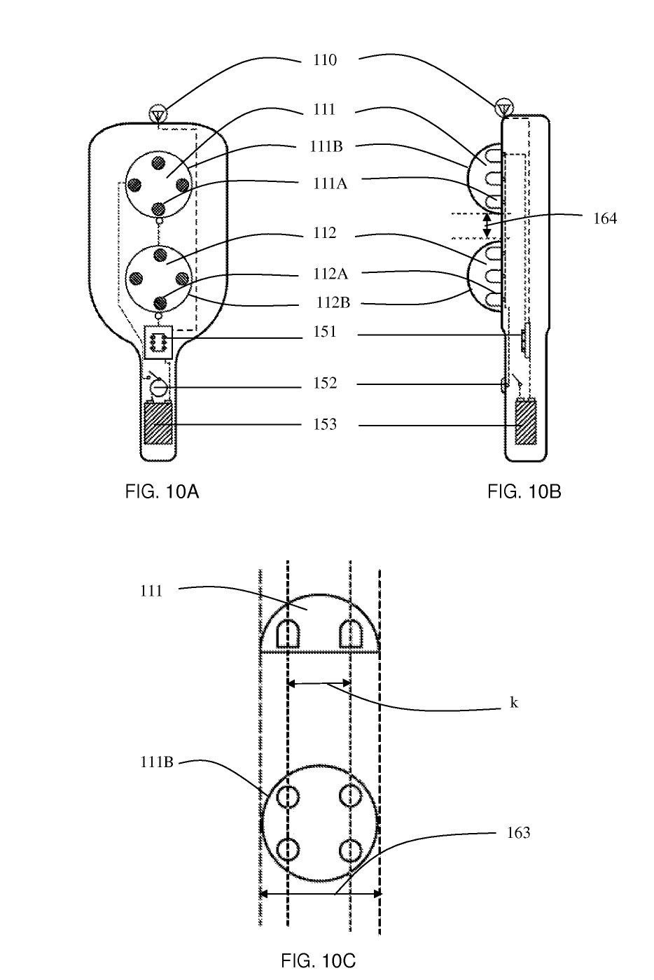

FIG. 10A and FIG. 10B are simple illustrations showing respectively the frontal and lateral cross-section of the control device in accordance with another embodiment of the present invention. The control device comprises a radio frequency (RF) antenna 110, a primary light source 111 which includes four 5 mm white LEDs such as LED 111A configured underneath a color filter 111B, a secondary light source 112 which includes four 5 mm white LEDs such as LED 112A configured underneath a color filter 112B, an integrated circuit 151 for controlling the RF antenna 110 and the electricity supply to the LEDs, a battery for supplying 4.5V electricity to the LEDs and the RF antenna 110, and a switch 152 for controlling the powering on and off of the control device. The LEDs are super bright LEDs with 10000 millcandela (mcd) intensity. Light sources 111 and 112 are separated by a distance 164 of 1.5 cm. The luminosities of the color light sources 111 and 112 are configured to be bright enough such that their colors can be identified by the computing system through the image capturing device which is configured with low exposure.

FIG. 10C is a diagram showing one configuration of LEDs in the control device in accordance with another embodiment of the present invention. The primary light source 111 comprised four LEDs evenly located, forming two groups separated by a distance k. The diameter 163 of the hemispherical color filter 111B is 3 cm. The secondary light source 112 is structurally similar to primary light source 111.

FIG. 11A is a diagram showing a control device 100 being held in hand of a human 106 in one embodiment of the present invention.

FIG. 11B is another diagram showing a control device 100 being attached to the body of a human 106 in another embodiment of the present invention. One who is skilled in the art knows that other wearable configurations of the control device 100 can be designed to fit for the use by a human or adapt to requirements of the application. For example, users can attach a control device to a boxing glove to play a boxing game. It allows a more intuitive interaction in the game.

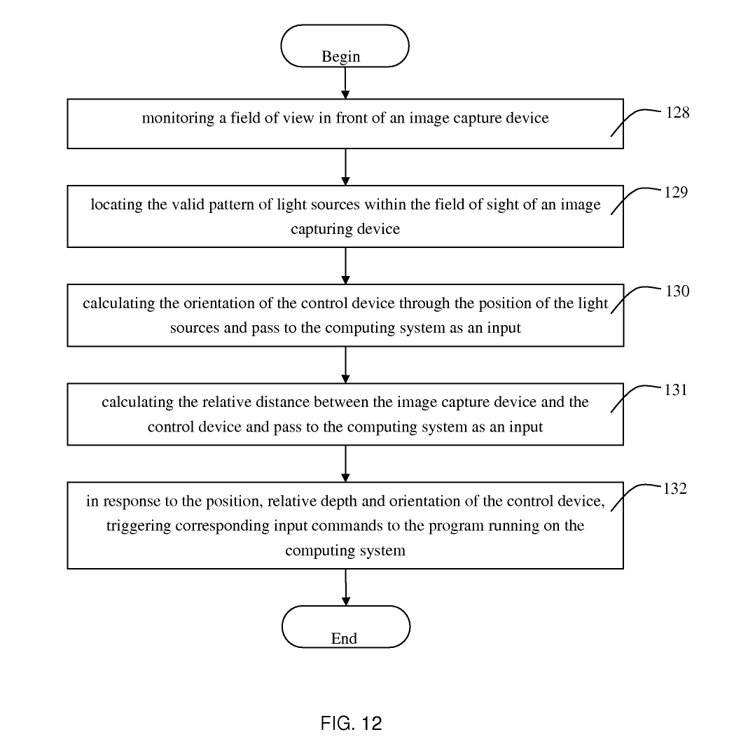

FIG. 12 is a flow chart diagram illustrating the method of getting input commands from a patterned color light source for a program run on a computing system. The method initiates with operation 128 where a field of sight of an image capturing device is monitored. The pattern of light source from the control device is captured through the image capturing device. This operation is described with reference to FIG. 1 and FIG. 3. The method then advances to operation 129 where the valid patterns of light sources within the field of sight are located. This operation is described with reference to FIG. 4A and FIG. 4B. The method then moves to operation 130 where the orientation of the control device is calculated, as described with reference to FIG. 5A and FIG. 5B. The method then proceeds to operation 131 where the relative distance between the image capturing device and the control device is calculated, as described with reference to FIG. 7A and FIG. 7B. The method then advances to operation 132 where input commands, corresponding to the 2-dimensional planar position, relative 3-dimensional depth, and orientation (roll) of the control device, are sent to a program running on a computing system. In one embodiment of the present invention, the position of the control device is associated with the position of a virtual pointer in a computing system. Therefore, a user can move the control device in the 3-dimensional space to control the virtual pointer on the displayed system of a computing system.

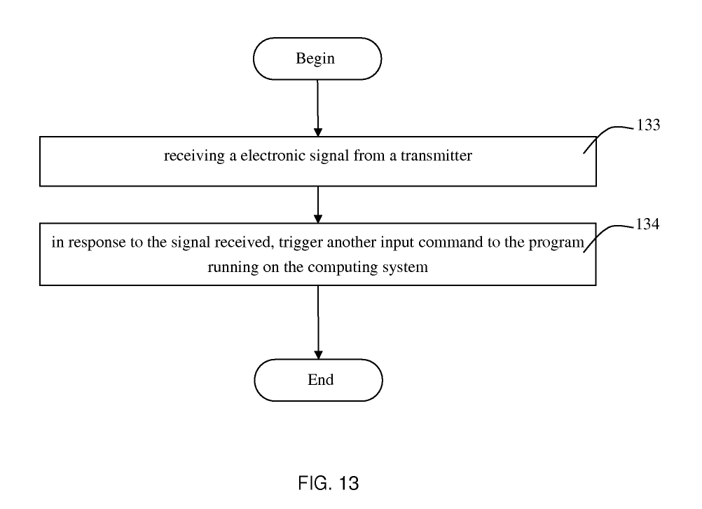

FIG. 13 is a flow chart diagram illustrating the method of getting input commands from electronic signals for a program run on a computing system. The method initiates with operation 133 where an electronic signal sending from an electronic signal transmitter affixed on a control device is received. This signal is triggered by the control device when the user presses a button on the control device. The control device is configured such that different signals will be sent when different buttons are pressed. The method then moves to operation 134 where an input command, corresponding to the signal received, is triggered at a program running on a computing system. As the user presses the button, a discrete event is triggered at a program running on a computing system. This event can be a mouse click event, a button selection of a game pad, or an event to trigger any function in the computing program.

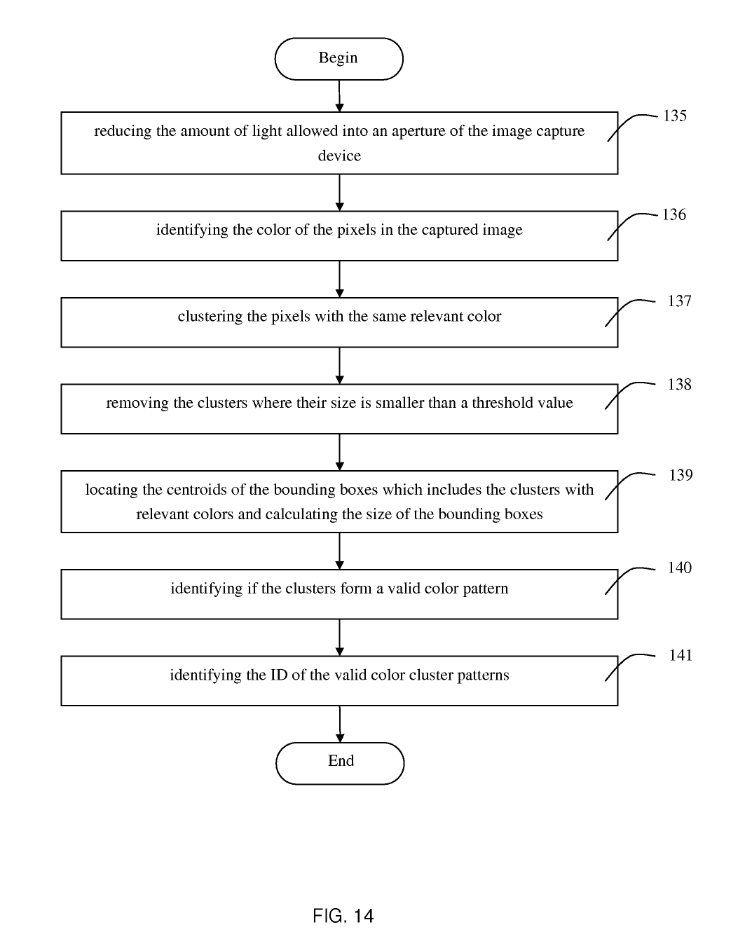

FIG. 14 is a flow chart diagram illustrating the method of pattern recognition for determining a valid pattern of color light sources. The method initiates with operation 135 where a pattern of light source is captured and appears in the captured image. The method then moves to operation 136 where the colors of the pixels in the captured image are identified. The method then advances to operation 137 where the pixels with the same relevant color are clustered. The method then proceeds to operation 138 where the clusters with size smaller than a threshold value are removed. The method then moves to the operation 139 where the centroids of bounding boxes including the clusters with relevant colors are located and the sizes the bounding boxes calculated. The method then advances to operation 140 where the clusters are checked if it forms a valid color pattern, as described with reference to FIG. 4A and FIG. 4B. The method then proceeds to operation 141 where the IDs of valid color light patterns are identified according to the color combinations of valid color cluster patterns.

To summarize, the present invention provides a robust method and apparatus for use as a control device for controlling a computing system, in an unconstrained, uncalibrated “colorful” living environment. The method includes a hybrid sensing system comprised of computer-vision-based pattern recognition and electronic signal transmission. The movement of a control device affixed with a designated patterned color light source in the 3-dimensional space within the field of sight of a video image capturing device can control a virtual pointer in a computing system. The activation of the electronic signal transmitter by pressing a control button on the control device will trigger input commands to the computing system. Multiple control devices are allowed to used simultaneously and thus multiple inputs are enabled.

One who is skilled in the art can find many applications of this control device. In one embodiment of the present invention, the user can control the 3-dimensional movement of a mouse by moving the control device in the 3-dimensional space and perform a mouse click by pressing a control button on the control device. The user can also perform other mouse operation like drag and drop, point and click using this control device. Yet apparently, its applications are not limited to mouse operation. The control device of present invention is an intuitive input device which facilitates human to communicate with the computer system.

1. A method of getting input commands for a program running on a computing system, the method comprising:
monitoring a field of view in front of an image capturing device;
locating the 2-dimensional planar position of a patterned color light source, within the field of view of an image capturing device;
calculating the 3-dimensional orientation of the patterned color light source;
calculating the relative distance between the image capturing device and the patterned color light source;
in response to the 2-dimensional planar position, the relative 3-dimensional position and the orientation or roll of the patterned color light source, triggering a corresponding first input command to a program running on the computing system;
receiving an electronic signal from an electronic signal transmitter;
in response to the signal received, triggering a corresponding second input command to the program running on the computing system.

2. The method of claim 1, wherein the patterned color light source is configured in a pattern of two or more than two contrasting color light sources located adjacent to each other.

3. The method of claim 1, wherein the light source comprises one or more light emitting diodes, light bulbs, light reflectors or combinations of light emitting diodes, light bulbs and light reflectors.

4. The method of claim 1, wherein the electronic signal is received via wire or wirelessly and optionally is a radio frequency (RF) signal or an infrared (IR) signal.

5. The method of claim 1, wherein locating of a patterned color light source comprises:
reducing the amount of light allowed into an aperture of the image capturing device;
capturing an image of the patterned color light source with the image capturing device;
identifying the color of the pixels in the captured image;
clustering the pixels in groups of relevant color;
removing clusters having a size smaller than a threshold value;
locating bounding boxes including the clusters with relevant colors;
calculating the centroids of the bounding boxes;
identifying whether the clusters form a valid color pattern;
determining the identity of the patterned color light source.

6. The method of claim 1, wherein the orientation of the patterned color light source is the roll of the patterned color light source and optionally is calculated by finding the slope of a line passing through the centroids of the two color light sources configured on the patterned color light source.

7. The method of claim 1, wherein the relative distance between the image capturing device and the patterned color light source is determined by comparing the sizes of the bounding box of the primary color light source in two successive captured images.

8. The method of claim 1, wherein the corresponding first input command is the identity, the 2-dimensional planar position, the relative 3-dimensional position, and the orientation or roll of a virtual pointer on a digitized screen of the computing system, wherein the identity, the 2-dimensional planar position, the relative 3-dimensional position, and the orientation or roll of the virtual pointer are associated with the identity, 2-dimensional planar position, relative 3-dimensional position, and orientation or roll of the patterned color light source.

9. The method of claim 1, wherein the corresponding second input command is associated with a mouse-down command or a button-click command in the computing system.

10. The method of claim 5, wherein reducing the amount of light allowed into the aperture of the image capturing device comprises filtering out reflective colors and weak environmental light sources from the captured image background.

11. The method of claim 5, wherein a grid associated with the digitized screen of the image capturing device is a sampled grid or a complete grid associated with a digitized screen of the image capturing device and wherein different resolutions of the grid optionally are used according to desired accuracy and performance.

12. The method of claim 5, wherein the identification of the color of the pixels, or a selected group of the pixels, in the captured image includes:
reading the pixel value of a pixel generated by the light source; and
classifying the color of the generated pixel based on the pixel value.

13. The method of claim 5, wherein the identifying of whether there is a valid color cluster pattern includes:
calculating the distance between the centroids of the bounding boxes that include clusters with the relevant color; and
determining the validity of the pattern according to whether the centroid-to-centroid distance is less than a threshold.

14. The method of claim 5, wherein the identification of the identity of a patterned color light source includes:
matching the colors in a valid color cluster pattern with a list of the pre-defined color combinations, wherein the pre-defined color combinations correspond to the designated identities of the patterned color light sources.

15. The method of claim 1, comprising program instructions stored on a computer readable medium, or implemented on a computing system, the computing system comprising a game console, a general-purpose computer, a networked computer, a distributed processing computer or an embedded system and wherein each logic element in the computing system comprises a hardware element, a software element, or a combination of hardware and software elements.

16. The method of claim 15, wherein the computing system comprising an image capturing device, wherein the image capturing device is a webcam, a digital camera, a camera coupled with a digitizer, or an array of charge coupled devices (CCDs), wherein the image capturing device is operable in a normal living environment, lighted by daylight or artificial light and wherever the computing system provides an automatic or manual calibration of the white balance by the image capturing device to adapt the image sensor to the color temperature of the light source.

17. A control device useful for interfacing with a computing system, the control device comprising:
a patterned color light source, wherein the identity, the 2-dimensional planar position, the relative 3-dimensional position, and the orientation or roll of the patterned color light source are capable of being detected and identified by the computing system;
an electronic signal transmitter capable of sending electronic signals to the computing system to trigger input commands to a computing program running on the computing system;
one or more control buttons for triggering electronic signal transmission; and
a portable power supply for the light source and the electronic signal transmitter.

18. The control device of claim 17, wherein the identity, the 2-dimensional planar position, the relative 3-dimensional position, and the orientation or roll of the patterned color light source configured on the control device are respectively associated with the identity, the 2-dimensional planar position, the relative 3-dimensional position, and the orientation or roll of the control device.

19. The control device of claim 17, wherein multiple control devices configured with different patterned color light sources are capable of being simultaneously detected and identified by the computing system.

20. The control device of claim 17, wherein each color light source is a light source configured behind a semi-transparent color filter, or a light source configured with an array of color lights.

21. The control device of claim 17, wherein the control buttons are configured to trigger the sending of different electronic signals through the electronic signal transmitter.

22. The control device of claim 17, constructed to be held in a human hand or to be attached to the body or apparel of a human being.
